(19) United States
(12) Patent Application Publication
(10) Pub. No.: US 2019/0063933 A1
(43) Pub. Date: Feb. 28, 2019

(54) METHOD AND DEVICE FOR DETERMINING A HIGHLY PRECISE POSITION AND FOR OPERATING AN AUTOMATED VEHICLE

(71) Applicant: Robert Bosch GmbH, Stuttgart (DE)

(72) Inventors: Daniel Zaum, Sarstedt (DE); Holger Mielenz, Ostfildern (DE); Jan Rohde, Stuttgart (DE)

(21) Appl. No.: 16/109,219

(22) Filed: Aug. 22, 2018

(30) Foreign Application Priority Data
Aug. 23, 2017 (DE) 102017214731.8

(51) Int. Cl. G01C 21/32; G05D 1/00; G06F 17/30

(52) U.S. Cl. CPC G01C 21/32; G05D 2201/0213; G06F 17/30241; G05D 1/0088

(57) ABSTRACT

A method and device determine a highly precise position of, and operate, an automated vehicle by receiving map data values, which represent a map, from an external server, the map including light-specific surroundings features; determining a light-specific surroundings state; detecting surroundings data values that represent the surroundings of the automated vehicle, the surroundings including light sources; determining the highly precise position based on a comparison between the light-specific surroundings features and the light sources and as a function of the light-specific surroundings state; and operating the automated vehicle as a function of the highly precise position.

### CROSS-REFERENCE TO RELATED APPLICATIONS

The present application claims priority under 35 U.S.C. § 119 to DE 10 2017 214 731.8, filed in the Federal Republic of Germany on Aug. 23, 2017, the content of which is hereby incorporated by reference herein in its entirety.

### FIELD OF THE INVENTION

The present invention relates to a method as well as a device for determining a highly precise position and for operating an automated vehicle, including a step of receiving map data values from an external server, a step of determining a light-specific surroundings state, a step of detecting surroundings data values, a step of determining the highly precise position, and a step of operating the automated vehicle as a function of the highly precise position.

### SUMMARY

According to an example embodiment of the present invention, a method for determining a highly precise position and for operating an automated vehicle includes a step of receiving map data values from an external server, which represent a map, the map including light-specific surroundings features, a step of determining a light-specific surroundings state, and a step of detecting surroundings data values, the surroundings data values representing the surroundings of the automated vehicle, the surroundings including light sources. The method according to the present invention further includes a step of determining the highly precise position based on a comparison between the light-specific surroundings features and the light sources as a function of the light-specific surroundings state, and a step of operating the automated vehicle as a function of the highly precise position.

An automated vehicle is understood to mean a semi, highly, or fully automated vehicle.

Operating an automated vehicle is understood to mean that the automated vehicle is operated in a semi, highly, or fully automated manner. In this case, operating includes, for example, determining a trajectory for the automated vehicle and/or driving along this trajectory with the aid of an automated transversal and/or longitudinal control and/or carrying out safety-relevant driving functions, etc.

A highly precise position is understood to mean a position which is precise within a predefined coordinate system, for example GNSS coordinates, in such a way that this position does not exceed a maximally admissible imprecision. In this case, the maximum imprecision can be a function of the surroundings of the automated vehicle, for example. Furthermore, the maximum imprecision can, for example, be a function of whether the automated vehicle is operated in a semi, highly, or fully automated manner. In principle, the maximum imprecision is low enough to ensure safe operation of the automated vehicle. For the purpose of operating the automated vehicle in a fully automated manner, the maximum imprecision is, for example, within an order of magnitude of approximately 10 centimeters.

Surroundings of the automated vehicle are, for example, to be understood to mean an area which can be detected with the aid of surroundings sensors of the vehicle.

A map is, for example, to be understood to mean a digital map which is designed to localize the automated vehicle and/or to carry out a function dependent on the locality, etc., in conjunction with a navigation system and/or a control unit of the automated vehicle and/or in conjunction with a smart phone which is connected to the automated vehicle or encompassed by same.

The method according to the present invention advantageously achieves a safe and reliable operation of an automated vehicle in many cases based on the knowledge of a highly precise position of the automated vehicle. In general, multiple methods are available for determining the highly precise position, some of the methods working more reliably than others, depending on certain environmental influences, for example. The method described here supports the determination of the highly precise position, in particular with the aid of light-specific surroundings features and light sources.

Preferably, relevant light sources and non-relevant light sources are differentiated as a function of the light-specific surroundings state, the non-relevant light sources being filtered out.

Relevant and non-relevant light sources are, for example, to be understood to mean natural and/or artificial light sources. A natural light source is represented by the sun, for example, which assumes a specific position in the sky at a specific time of day and/or time of year, whereby its light beams also generate specific light reflections in each case, in the form of brightened surfaces and/or brightened areas, in the surroundings of the automated vehicle. An artificial light source is represented by a street light, for example, whose light beams cannot be detected directly, for example, and which, however, generate light reflections in each case at specific positions in the surroundings of the automated vehicle.

This proves advantageous in that by filtering out the non-relevant light sources, the reliability and/or the precision of determining the highly precise position and thus the safety when operating the automated vehicle is increased.

Preferably, an evaluation of the comparison is carried out according to predefined criteria, at least one of the relevant light sources being transmitted to the external server as a function of the evaluation.

The predefined criteria establish, for example, whether or not the at least one of the relevant light sources could be detected at a highly precise position, this at least one light source only being transmitted if the highly precise position is known.

This proves advantageous in that the automated vehicle itself contributes, for example, to an improvement and/or update of the map which can then be made available to other (automated) vehicles.

The highly precise position is preferably determined based on at least one position of the light sources, the at least one position being a function of a time of day and/or a time of year.

This proves advantageous in that the range of applications for determining the highly precise position can be used variably by taking into consideration the time of day and/or the time of year, thus increasing the safety when operating the automated vehicle.

According to an example embodiment of the present invention, a device for determining a highly precise position and for operating an automated vehicle includes first means for receiving map data values from an external server, which represent a map, the map including light-specific surroundings features, second means for determining a light-specific surroundings state, and third means for detecting surroundings data values, the surroundings data values representing the surroundings of the automated vehicle, the surroundings including light sources. The device according to the present invention further includes fourth means for determining the highly precise position based on a comparison between the light-specific surroundings features and the light sources as a function of the light-specific surroundings state, and fifth means for operating the automated vehicle as a function of the highly precise position.

Preferably, the first means and/or the second means and/or the third means and/or the fourth means and/or the fifth means are designed to carry out a method according to at least one of the method claims.

Exemplary embodiments of the present invention are illustrated in the drawings and explained in greater detail in the descriptions below.

### BRIEF DESCRIPTION OF THE DRAWINGS

FIG. 1 illustrates a device according to an example embodiment of the present invention.

FIG. 2 illustrates a device according to another example embodiment of the present invention.

FIG. 3 is a flowchart that illustrates a method according to an example embodiment of the present invention.

### DETAILED DESCRIPTION

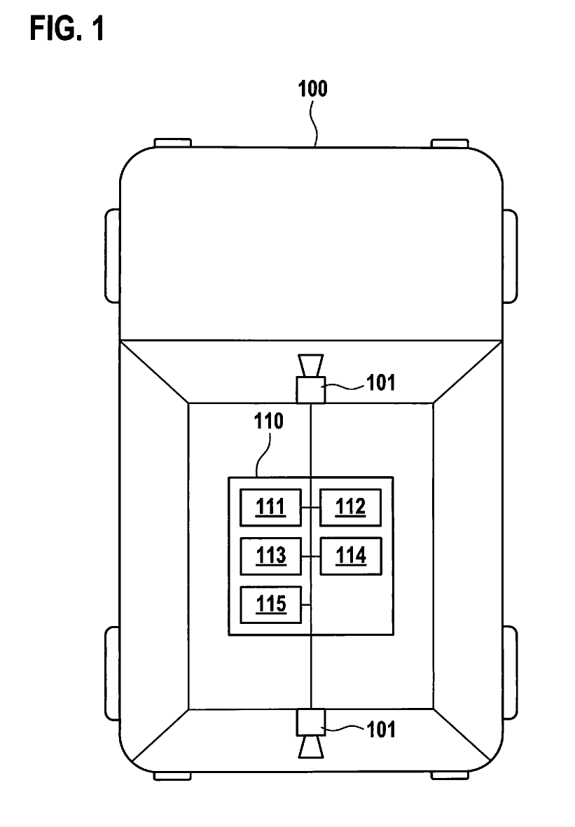

FIG. 1 shows an automated vehicle 100 which includes device 110 according to the present invention for determining 340 a highly precise position 150 and for operating 350 automated vehicle 100.

Device 110 includes first means 111 for receiving 310 map data values from an external server 210 which represent a map, the map including light-specific surroundings features 220, second means 112 for determining 320 a light-specific surroundings state, and third means 113 for detecting 330 surroundings data values, the surroundings data values representing surroundings 200 of automated vehicle 100, surroundings 200 including light sources 230. Device 110 further includes fourth means 114 for determining 340 highly precise position 150 based on a comparison between light-specific surroundings features 220 and light sources 230 as a function of the light-specific surroundings state, and fifth means 115 for operating 350 automated vehicle 100 as a function of highly precise position 150.

First means 111 for receiving 310 map data values from an external server 210 are designed as a transmitting and/or receiving unit, for example. In another example embodiment, first means 111 are designed in such a way that they are connected to a transmitting and/or receiving unit which is/are already encompassed by the vehicle.

Second means 112 for determining 320 a light-specific surroundings state are designed as a transmitting and/or receiving unit, for example, which requests the light-specific surroundings state from a weather station and/or from a further external server, for example. In an example embodiment, the transmitting and/or receiving unit is identical to the transmitting and/or receiving unit of first means 111.

In another example embodiment, second means 112 are designed in such a way that the light-specific surroundings state is determined with the aid of surroundings sensors 101 which are encompassed by automated vehicle 100. For this purpose, second means 112 include, for example, a processing unit (processor, random access memory, hard drive, software) which is designed to evaluate the surroundings data detected with the aid of surroundings sensors 101, for example in the form of an image by a video sensor and/or in the form of light intensity values by a light intensity sensor.

Third means 113 for detecting 330 surroundings data values are designed, for example, in such a way that they include dedicated surroundings sensors or are connected to surroundings sensors 101 which are already encompassed by automated vehicle 100. Furthermore, third means 113 include a processing unit (processor, random access memory, hard drive, software), for example, which processes and evaluates the surroundings data values.

Surroundings sensors 101 are, for example, to be understood to mean at least one video and/or at least one radar and/or at least one LIDAR and/or at least one ultrasonic and/or at least one further sensor which is/are designed to detect surroundings 200 of automated vehicle 100 in the form of surroundings data values.

Fourth means 114 for determining 340 highly precise position 150 based on a comparison between light-specific surroundings features 220 and light sources 230 as a function of the light-specific surroundings state, are designed as a control unit and/or a processing unit, for example, which include(s) a processor, random access memory, and a hard drive as well as suitable software, for example, for determining 340 a highly precise position 150 of automated vehicle 100.

Fifth means 115 for operating 350 automated vehicle 100 as a function of highly precise position 150 are designed as a control unit, for example.

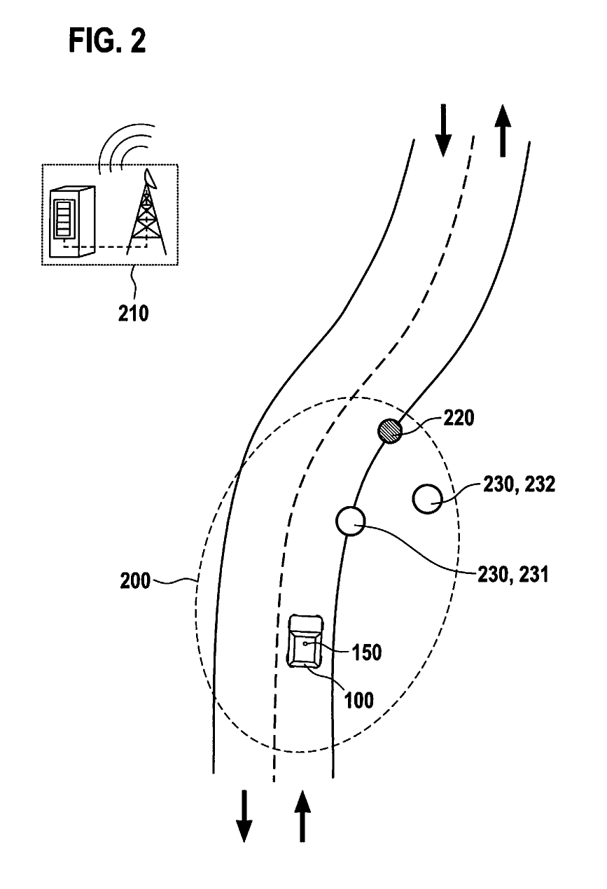

FIG. 2 shows a schematic illustration of one exemplary embodiment of method 300 according to the present invention. Here, automated vehicle 100 drives automatically on a road.

The automated vehicle receives map data values, which represent a map, from an external server 210 with the aid of first means 111, the map including light-specific surroundings features 220. In an example embodiment, the map data values are received, for example, at regular time and/or location intervals as a function of the (not highly precise) position of automated vehicle 100. In another example embodiment, automated vehicle 100 requests, for example, the map data values if an instantaneous map is not available and/or a determination 340 of a highly precise position 150 is not possible. In another example embodiment, the map data values are transmitted by external server 210 when the map has been updated, for example.

Automated vehicle 100 further determines a light-specific surroundings state with the aid of second means 112. In an example embodiment, this step takes place in that the light-specific surroundings state is transmitted together with the map data values by external server 210 and received with the aid of first means 111. In another example embodiment, the light-specific surroundings state is determined independently of the received map data values, for example with the aid of surroundings sensors 101 of automated vehicle 100.

Automated vehicle 100 further detects surroundings data values, the surroundings data values representing surroundings 200 of automated vehicle 100, surroundings 200 including light sources 230.

In an example embodiment, two light sources 231, 232 are detected as light sources 230, for example, a relevant light source 231 and a non-relevant light source 232 being differentiated as a function of the light-specific surroundings state (surroundings brightness, incident sun light in conjunction with a strongly or mildly reflecting surface, etc.), non-relevant light source 232 subsequently being filtered out with the aid of suitable filtering processes (for example with the aid of a suitable filtering software).

For example, relevant light source 231 is designed as a street light and non-relevant light source 232 as an illuminated billboard. Since the light of the billboard makes it more difficult, however, to detect the street light in the sense of this example embodiment, non-relevant light source 232 is filtered out. Subsequently, highly precise position 150 of automated vehicle 100 is determined based on a comparison between light-specific surroundings feature 220 and the (relevant) light source 230 as a function of the light-specific surroundings state. In an example embodiment, the light-specific surroundings state is used, for example, to determine actual highly precise position 150, since corresponding parameters are used for determining based on this state.

Highly precise position 150 is determined, for example, by detecting light source 230, 231 and by determining a relative position of automated vehicle 100 thereto. This takes place, for example, with the aid of a direction vector and a distance between light source 230, 231 and automated vehicle 100. Since the likewise highly precise position of light-specific surroundings feature 220 is stored in the map data values, highly precise position 150 of automated vehicle 100 is determined based on this position and the relative position, for example with the aid of vector addition.

In an example embodiment, a light source 230, which is not encompassed by the map, is detected by automated vehicle 100, for example, and transmitted to external server 210.

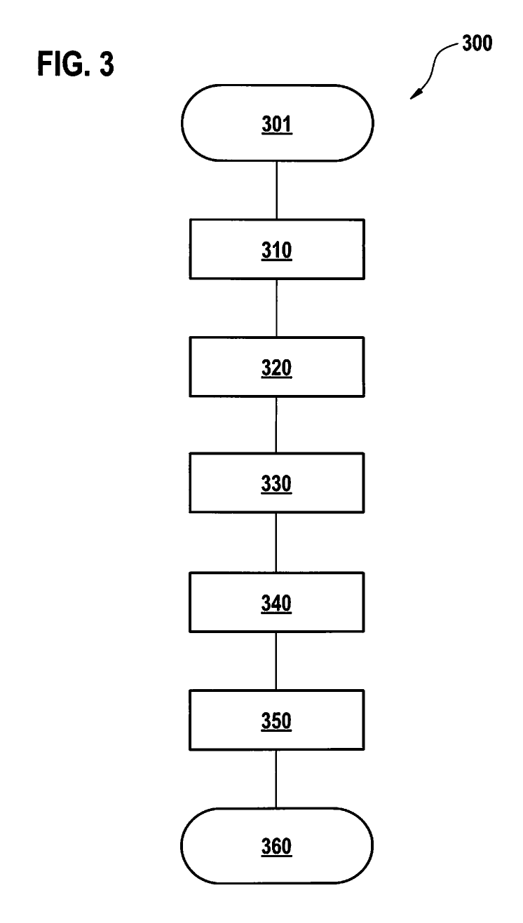

FIG. 3 shows one exemplary embodiment of a method 300 for determining 340 a highly precise position 150 and for operating 350 an automated vehicle 100. Method 300 starts in step 301. In step 310, map data values are received from an external server 210, which represent a map, the map including light-specific surroundings features 220. In step 320, a light-specific surroundings state is determined. In step 330, surroundings data values are detected, the surroundings data values representing surroundings 200 of automated vehicle 100, surroundings 200 including light sources 230. In step 340, a highly precise position 150 is determined based on a comparison between light-specific surroundings features 220 and light sources 230 as a function of the light-specific surroundings state. In step 350, automated vehicle 100 is operated as a function of highly precise position 150. Method 300 ends in step 360.

What is claimed is:

1. A method comprising:
receiving, by an automated vehicle and from an external server, map data values that represent a map, the map including light-specific surroundings features;
determining a light-specific surroundings state;
detecting surroundings data values that represent light sources surrounding the automated vehicle;
determining a highly precise position of the automated vehicle based on the light-specific surroundings state and based on a comparison between the light-specific surroundings features and the light sources represented by the surroundings data values; and
operating the automated vehicle based on the determined highly precise position.

2. The method of claim 1, wherein the detecting includes:
distinguishing between relevant light sources and non-relevant light sources based on the light-specific surroundings state; and
filtering out the non-relevant light sources, so that only the relevant light sources are used as the light sources of the comparison.

3. The method of claim 2, wherein:
an evaluation of the comparison is carried out according to predefined criteria; and
at least one of the relevant light sources is transmitted to the external server as a function of the evaluation.

4. The method of claim 1, wherein:
the highly precise position is determined based on at least one position of the light sources; and
the at least one position is a function of at least one of a time of day and a time of year.

5. A device of an automated vehicle, the device comprising:
a receiver;
at least one sensor; and
a processor;
wherein:
the receiver is configured to receive from an external server map data values that represent a map, the map including light-specific surroundings features;
the at least one sensor is configured to detect or the receiver is configured to receive a light-specific surroundings state;
the at least one sensor is configured to detect surroundings data values that represent light sources surrounding the automated vehicle; and
the processor is configured to:
determine a highly precise position of the automated vehicle based on the light-specific surroundings state and based on a comparison between the light-specific surroundings features and the light sources represented by the surroundings data values; and
operate the automated vehicle based on the determined highly precise position.
